(19) United States
(12) Patent Application Publication
(10) Pub. No.: US 2007/0091615 A1
(43) Pub. Date: Apr. 26, 2007

(54) Backlight module for LCD monitors and method of backlighting the same

(76) Inventors: Chi-Tang Hsieh, Chung Ho City (TW); Po-Laung Huang, Chung Ho City (TW); Chan-Ching Lin, Chung Ho City (TW)

Correspondence Address: LIN & ASSOCIATES INTELLECTUAL PROPERTY, P.O. BOX 2339, SARATOGA, CA, 95070-0339, US

(21) Appl. No.: 11/258,534

(22) Filed: Oct. 25, 2005

(51) Int. Cl. F21V 5/04

(52) U.S. Cl. 362/335; 362/340

(57) ABSTRACT

A backlight module for LCD monitors and method of backlighting are disclosed, in which a dome-shaped lens and a LED light source are employed in the backlight module. This method includes the preparation of a LED light source and a dome lens, fitting the dome lens over the light source, attaching the dome lens and the light source under the optical lens sheets, whereby the optical lens sheet closest to the light source is at a vertical distance X therefrom. The hemispherical lens provides light coverage on the optical lens sheet in a peripheral areas with diameters ranging from 2X to 7X, as compared with the small area (diameter X) using the conventional technique. The dome lens is constructed with a light emergent plane on one side, and a light incident plane around hollow cavity in the center.

### BACKGROUND OF THE INVENTION

1. Field of the Invention

The present invention relates to a new backlight module for LCD monitors and a method of backlighting, and in particular to a method of backlighting using a dome lens and a LED light source that is able to cover extremely wide peripheral areas.

2. The Related Art

The liquid crystal displays (LCD) with the advantages of small size and light weight are initially used on notebook computers and small electronic devices, but through continuous research on brightness and coloration enhancing techniques, the LCD panels are now gradually used in large flat-panel displays and wide-screen television sets.

Generally, the LCD monitors have two basic modes: transmissive and reflective. In transmissive mode, the LCD pixels are illuminated from behind using a cold cathode fluorescent lamp (CCFL) or light emitting diode (LED).

Transmissive LCDs offer wide color range, high contrast and are typically used in notebook computers. Transmissive LCDs offer the best performance under dimmer lighting conditions.

In reflective LCDs, the pixels are illuminated from the same side as the viewer. Reflective LCD pixels reflect light originating from the ambient environment or from a front light. Reflective LCDs can offer very low power consumption and are often used in small portable devices such as handheld games or portable devices. Reflective LCDs offer the best performance under brighter lighting conditions.

The earlier LCD monitors are mostly the reflective type, but increasing number of LCD products are changed over to the transmissive type, which is now the dominant display technology.

The light source of the transmissive LCDs can be classified into side-edge type and direct type. For a side-edge type, the light source is installed on one side of the light guide plate, and then through a diffusion plate and a prism, the light is uniformly distributed over the surface of the optical lens. A direct type has the light source placed directly under or behind the lens. The direct type back light module offers high brightness, wide viewing angle, high contrasts, and longer service life, making it a better choice over the side-edge type.

Referring to FIG. 1, the known LCD module is formed by a backlight module 20 and a LCD panel 10, where the construction of the backlight module 20 is further broken down into a prism lens 21, diffuser sheet 22, a light guide plate 23, a reflector box 24, and a light source 25. The direct type backlight module is extensively used for electroluminescent lamp (EL), cold cathode fluorescent lamp (CCFL), cold cathode lamp (CCL), or halogen lamp, in which the CCFL has the widest application.

With regard to the light distribution path, the light beams incident from the CCFL lamps directly pass through the light guide plate 23, the diffuser sheet 22, and the prism lens 21, and then the diffused light re-emerges on the opposite side of the backlight module 20 for projection onto the LCD panel 10.

The direct type backlight module uses multiple CCFL lamp tubes behind the LCD panel, so the light can easily pass through the diffuser sheet and light guide plate (in some cases without using a light guide plate). This backlighting technique is easier to implement compared with the side-edge type, and prevents light loss to the surrounding. Therefore, the overall brightness and homogeneity of the LCD display can be maintained at high levels.

However, these CCFL lamp tubes tend to cause heat accumulation at a fast rate, which could be a problem to the operation of liquid crystal cells and color resist over the LCD filter, which might lead to color distortion. The counter measure is to increase the thickness of the backlight module to minimize the heating effect.

Further, due to the light distribution characteristics and the arrangement of the multiple CCFL lamp tubes in the conventional backlight modules, the lamp tubes may cause alternate shadow bands over the display screen to affect the light homogeneity.

The recent introduction of LED as a light source for backlight modules is well received by the market, because LEDs can fit in all shapes regardless of size and thickness, lower voltage power consumption, longer service life, simple driving circuit, and flickering-free dimming control. With the continuous development in this technology, the brightness and production cost factors have considerably improved. LED is now the most often used light source for backlight modules, replacing CCFL lamps and others, and is increasingly used in conventional lighting to replace tungsten light bulbs and fluorescent lamps.

However, in order to use the LED as a light source for backlight module certain technical problems still needs to be overcome. Referring to FIG. 2, for example, SMD LED with 2θ_{1/2} 120 degree is used as a light source, where θ_{1/2} represents the included angle between the light emission angle with 50% of the original intensity in the axial direction, and 2θ_{1/2} is the viewing angle. Applying this to the conventional LED backlighting technique, it is only possible to attain 65% light homogeneity in the peripheral area with diameter X.

Referring to FIG. 3, it can be seem that the light intensity is the strongest when the light emission angle is at 0 degree, that is in the axial direction, and further away from the center area, the intensity is progressively decreased. Therefore, the same applies to the conventional LED light source, the area around the center of the LED is the brightest, and the light cast on the lateral sides, farther away from the center area, is progressively decreased in intensity.

Normally, light incident from a LED lamp at a distance X can be homogeneously distributed in peripheral area with diameter X, but due to the fact that the light passes through diffusion plate with wide angle, and is projected from farther away, so the amount of light actually projected onto the planar lens is only able to achieve 65% light homogeneity around the perimeter of a peripheral area with diameter X.

Since the center area of the optical lens receives light with the highest intensity, and those on the lateral sides are progressively decreased in intensity the farther the distance from the center area. Under such conditions, in order to maintain certain minimum level of homogeneity of light, multiple LED lamps have to be used with increased production costs, but then there is the problem of alternate shadow lines affecting the image quality.

### SUMMARY OF THE INVENTION

The primary objective of the present invention is to provide a method of backlighting that enables significantly improvement on light homogeneity and light coverage as compared with the conventional technique. At the same time, it is possible to use less LED light sources but without sacrificing the LCD brightness and coloration.

The method of backlighting includes the provision of a dome lens, which has a light emergent plane on the top surface of the lens and a light incident plane around hollow cavity in the center, where the light incident plane is cone shaped that enables progressive decrease in curvature toward the outer periphery, and the light emergent plane is dished shaped that enables progressive increase in curvature toward the outer periphery.

The method of backlighting further includes the provision of a LED light source, to be coupled with the dome lens and disposed under the optical lens sheets, where the closest optical lens sheet is at vertical distance X therefrom, so the backlighting method enables extremely wide light pattern within a peripheral areas with diameters ranging from 2X to 7X, and the light homogeneity over 75%.

The backlight module for LCD monitors is characterized in that the dome lens is hemispherical, and has a dished shaped light emergence plane on one side and a cone shaped light incident plane on the opposite side, where the light incident plane progressively decreases in curvature from the vertical axis toward the outer periphery, and the light emergent plane progressively increases in curvature from the vertical axis toward the outer periphery.

The backlight module for LCD monitors is also characterized in that the light emergent plane is formed by multiple small hoop lenses in concentric orientation, and the surface of the light distribution lenses can be shaped with positive, zero, or negative curvature.

The backlight module for LCD monitors is also characterized in that the light emergent plane is formed by multiple smaller diamond shaped light distribution lenses, which are even smaller than the hoop lenses. Several of the diamond lenses are joined together to replace the previous hoop lens. This design enables wider viewing angle from multiple bands. The light emergent plane forms a grid pattern composing of multitude of slanted plates at different angles. The surface of the light distribution lenses can be shaped with positive, zero, or negative curvature. The curvature of each light distribution lens among the horizontal and vertical axis may be the same or different depending on the requirement specifications for the light distribution lens.

The method of backlighting is also characterized in that the light traveling path is to include a diffusion plate, which enables the incident light to cover a wider area, and more homogeneous light distribution. Using this technique, the light intensity can be suitably shifted from the central area to the peripheral area to achieve homogeneous light distribution within the peripheral area and homogeneity above 75%.

Therefore, using this method of backlighting, the light coverage area can be extremely large increasing by 4 to 49 times when compared with the conventional technique, while the overall light homogeneity and brightness are also significantly improved. This makes it possible to use less LED light sources to obtain the same or even better effects in brightness and coloration.

These along with other features of novelty which characterize the invention, are pointed out with particularity in the claims annexed to and forming a part of this disclosure. For a better understanding of the invention, the operating advantages and the specific objectives attained by its uses, references should be made to the accompanying drawings and descriptive matter illustrated in preferred embodiments of the invention.

### BRIEF DESCRIPTION OF THE DRAWINGS

FIG. 1 is the construction of a conventional LCD backlight module;

FIG. 2 is a diagram showing the light projection isosceles triangle for a conventional light source;

FIG. 3 is a diagram showing the relationship between the intensity and light emission angle using a conventional method of backlighting;

FIG. 4 is an exploded view of the construction of a backlight module in accordance with the present invention;

FIG. 5 is a sectional view of the dome lens in accordance with the present invention;

FIG. 6 is a diagram showing the light traveling paths through the light incident plane and light emergent plane of the dome lens, originated from the light source directly underneath the dome lens;

FIG. 7 is a diagram showing the relationship between the intensity and light emission angle in accordance with the first preferred embodiment of the invention;

FIG. 8 is a diagram showing the light projection from a LED light source onto the planar lens used in the first preferred embodiment of the invention;

FIG. 9 is a perspective view of the construction of a dome lens used in the second preferred embodiment;

FIG. 10 is a sectional view of the construction of a dome lens used in the second preferred embodiment;

FIG. 11 is a perspective view of the construction of a dome lens used in the third preferred embodiment;

FIG. 12 is a sectional view of the construction of a dome lens used in the third preferred embodiment;

FIG. 13 is a perspective view of the construction of a dome lens used in the fourth preferred embodiment;

FIG. 14 is a sectional view of the construction of the dome lens used in the fourth preferred embodiment;

FIG. 15 is a perspective view of the construction of a dome lens used in the fifth preferred embodiment;

FIG. 16 is a perspective view of the construction of a dome lens used in the sixth preferred embodiment;

FIG. 17 is a perspective view of the construction of a dome lens used in the seventh preferred embodiment;

FIG. 18 is a perspective view of the construction of a dome lens used in the eighth preferred embodiment; and

FIG. 19 is a sectional view of the construction of a dome lens used in the eighth preferred embodiment.

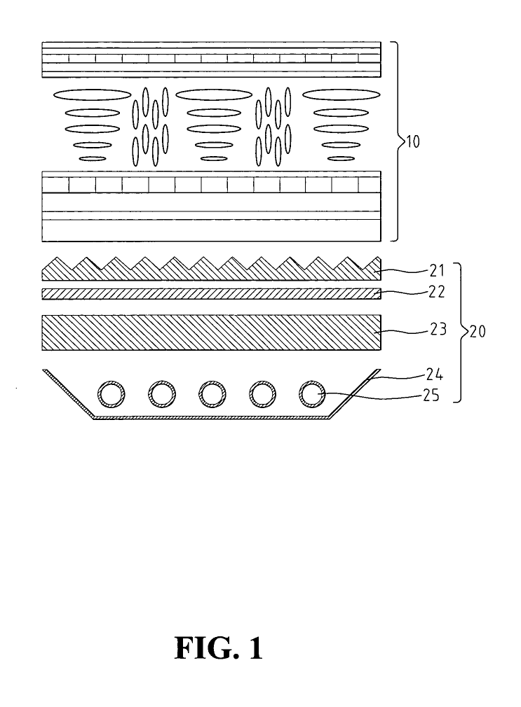

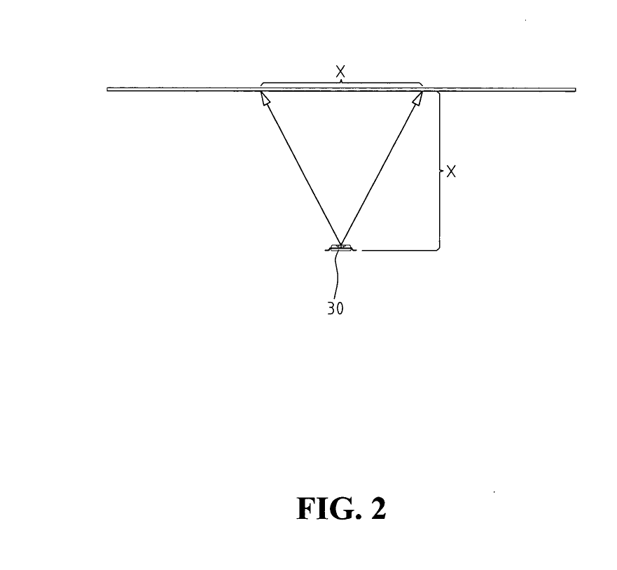

### DETAILED DESCRIPTION OF THE PREFERRED EMBODIMENT

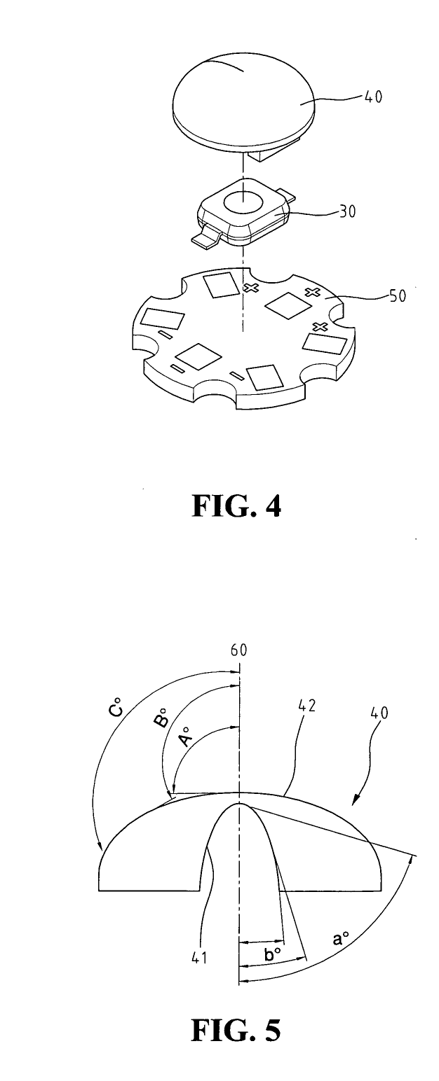

Referring to FIG. 4, the method of backlighting comprises the steps of: preparing a dome lens 40 and a LED light source 30, placing the dome lens 40 over the LED light source 30, and attaching the LED light source 30 and the dome lens 40 directly under the light distribution lenses, where the light source 30 is fixed on a holder 50 with power connection.

Referring to FIGS. 4, 5, the construction of the backlight module for LCD monitors, in accordance with the present invention, includes a dome lens 40, which is either hemispherical or semi-ellipsoidal body, composing of a light incident plane 41 and a light emergent plane 42.

Referring to FIG. 5, the dome lens 40 is hemispherical having the light incident plane 41 on one side and the light emergent plane 42 on the opposite side. The light incident plane 41 is cone shaped and formed around hollow cavity in the center. The light incident plane 41 is near the center of the dome lens 40 facing toward the LED light source 30 (shown in FIG. 4). The light emergent plane 42 is dished shaped facing toward the optical lens sheet closest to the LED light source 30. The construction of the light incident plane 41 enables progressive increase in curvature toward the center axis 60, whereas the light emergent plane 42 allows progressive decrease in curvature toward the center axis 60.

Still referring to FIG. 5, the center of the cone shaped light incident plane 41 coincides with the center axis 60, in such a way that the outward curved plane 41 progressively decreases in curvature from the center axis 60 to the outer periphery, as shown by the included angles at different points along the outward curved plane, angle_a>angle_b>angle_c, where the included angle is the angle measurement between the center axis 60 and the tangent line along the curved plane.

Conversely, the center of the dished shaped light emergent plane 42 also coincides with the center axis 60, in such a way that inward curved plane 42 progressively increases in curvature from the center axis 60 to the outer periphery, as shown by the included angles at different points along the inward curved plane, angle_A<angle_B<angle_C, where the included angle is the angle measurement between the center axis and the tangent line along the curved plane.

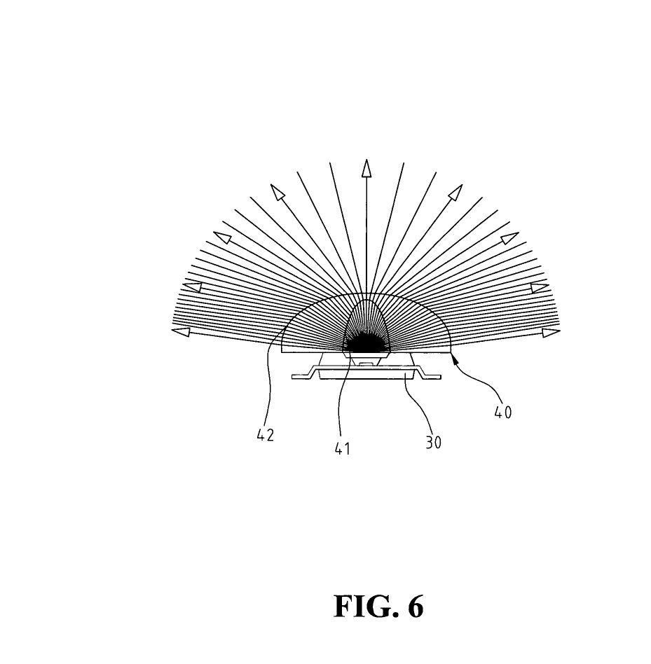

Referring to FIG. 6, with regard to the light distribution path through the dome lens 40, the light incident from the LED light source 30 undergoes two-stage refraction through the light incident plane 41 and the light emergent plane 42. The light is refracted for the first time as the LED light beams pass through the light incident plane 41 of the dome lens 40, and the light is refracted for the second time as the light comes out from the light emergent plane 42.

For the light incident plane 41, the curvature decreases toward the outer periphery, so the light beams traveling through the light incident plane 41 closer to the center axis 60 are more likely to be deflected than those traveling farther away from the center axis 60 on the lateral sides.

For the light emergent plane 42, the curvature increases toward the outer periphery, so the light beams traveling through the light emergent plane 42 closer to the center axis 60 are less likely to be deflected than those traveling farther away from the center axis 60. Therefore, the light coverage area can be substantially increased using the above mentioned lens construction.

The light intensity on the periphery can also be significantly increased beyond that near the center axis, and the light beams can travel farther to cover more distant areas, using the above mentioned method of backlighting.

The light beams incident from the LED light source 30 are fanned out as shown in FIG. 6, enabling large peripheral area to be covered. The light intensity on the peripheral area is supplemented by deflected light from the center axis 60, so the overall light homogeneity is better than the conventional technique. This enables the image quality on the LCD monitor to be noticeably improved.

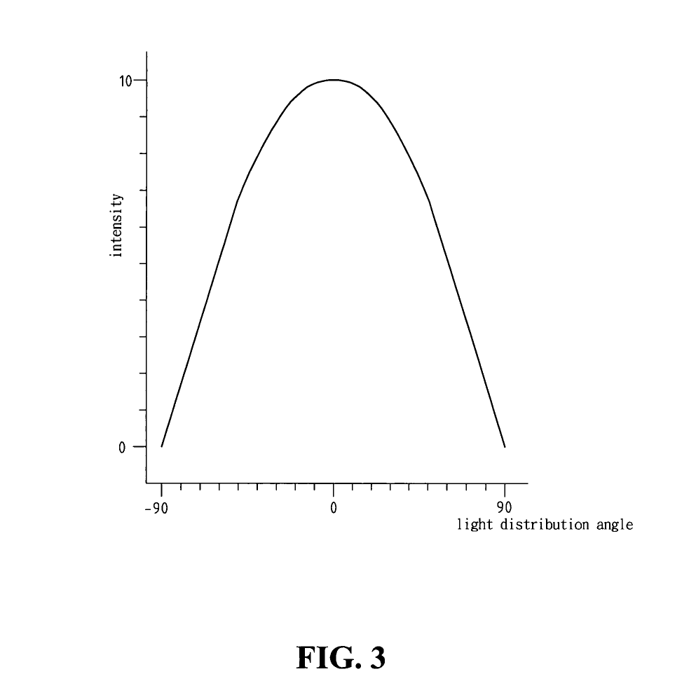

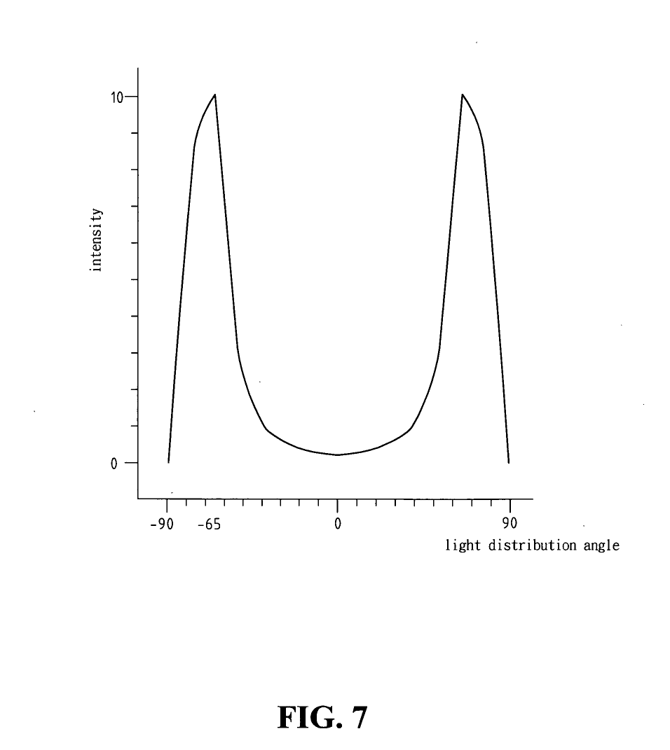

Referring to FIG. 7, it can be seem that the light intensity is the lowest when the light emission angle is in the axial orientation (0 degree), in accordance with the present invention, whereas the highest intensity is recorded in the axial orientation using the conventional backlighting technique as shown in FIG. 3. The light intensity reaches the peak level at the 70 degree angle, and beyond that the light intensity starts to drop off rapidly.

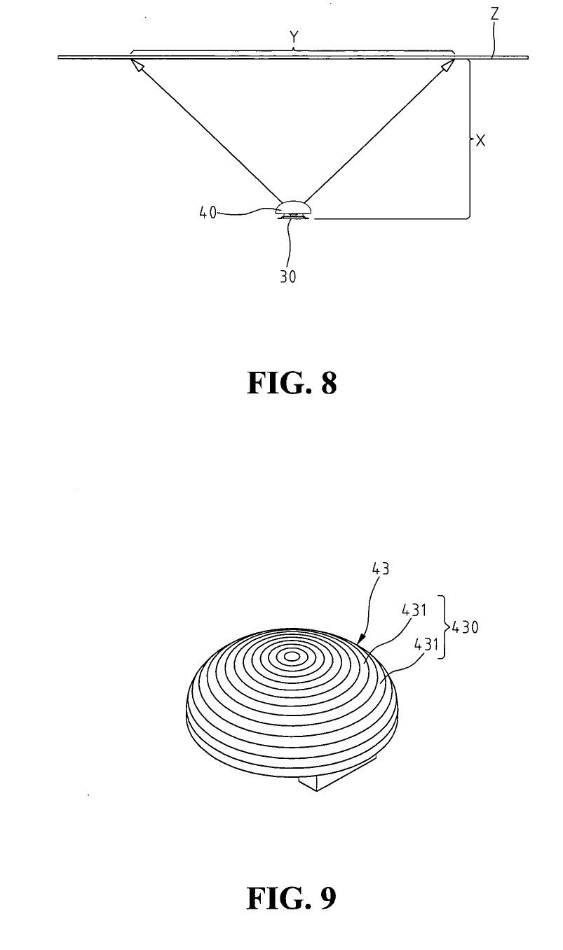

Referring to FIG. 8, a method of backlighting is provided in the first preferred embodiment, comprising the steps of: preparing a dome lens 40 and a LED light source 30, fitting the dome lens 40 onto the LED light source 30, placing the dome lens 40 and light source 30 directly under light distribution lenses C, whereby the closest optical lens sheet Z is at a vertical distance X from the light source 30, so light beams incident from the light source 30 are able to cover a wide peripheral area with diameter Y, where Y is greater than X.

The backlight module is characterized in that the dome lens 40 and light source 30 together are attached directly under the light distribution lenses C, in such a way that the optical lens sheet Z closest to the light source 30 is at a vertical distance X therefrom. When light beams incident from the light source 30 pass through the dome lens 40, the light incident plane 41 refracts the light for the first time, and then the light emergent plane 42 refracts the light before casting onto the optical lens sheet Z. a wide peripheral area with diameter Y is created on the surface of the optical lens sheet, where Y is 2 to 7 times longer than X. the LED light source can be SMD or other compatible light sources, and the color of light generated can be white light or other compatible colors.

Through the distribution of light by means of the dome lens 40 in accordance with the invention, the light beams can be deflected to the outer periphery around the center area. The light coverage area can be significantly increased because of light distribution over a wider range, and the light homogeneity within the peripheral area can be maintained above 75%. The light coverage area can be extremely wide increasing by 4 to 49 times as compared with the conventional technique.

Because of the improved light illumination performance through the present invention, it is possible to use less light sources to produce the equivalent illumination for the backlight module, without sacrificing the light intensity and coloration of the image, thus the production costs for the backlight modules can be competitively reduced.

Referring to FIG. 9, another backlight module construction is used in the second preferred embodiment of the invention, in which the light emergent plane 43 of the dome lens 40 is formed by multiple hoop lenses 430, where each hoop lens 430 can be a slanted plate 431 with zero curvature. The hoop lenses 431 are joined together in concentric formation to form a dished shape plane with undulating surface.

From the center axis of the dome shaped surface 40, tangent lines are drawn parallel to the curved surfaces formed by hoop lenses 431, so a different included angle is created between the center axis 60 and the tangent line for each hoop lens 431, starting from the inner most ring to the outer periphery. The included angle actually represents the curvature of the lens at a particular point on the curved plane.

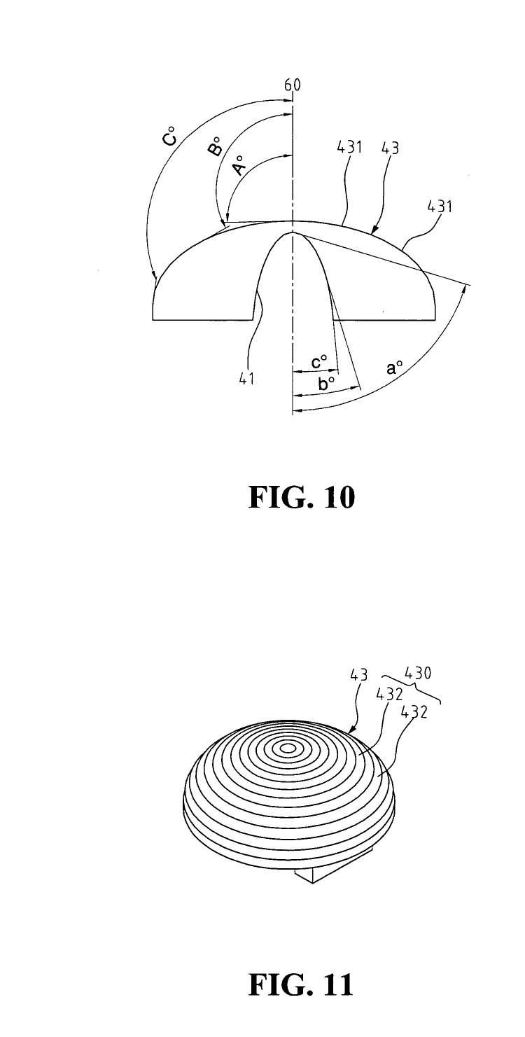

Referring to FIG. 10, for each point along the cone shaped plane 41, a tangent line is drawn parallel to curved surface of the cone shaped light incident plane 41, and an included angle is obtained between the tangent line and the vertical axis 60. It can be observed that the included angles corresponding to the tangent lines are progressively decreasing as the points move from the center axis 60 to the outer periphery, angle_a>angle_b>angle_c, which means the curvature of the cone shaped light incident plane 41 is progressively decreasing toward the outer periphery.

Still referring to FIGS. 9, 10, the light emergent plane 43 made up by multiple slanted plates 431 also experiences similar curvature transition but in the opposite direction. For each point along the dish shaped light emergent plane 43, a tangent line is drawn parallel to the curved surface on the light emergent plane 43, and a different included angle is obtained between the tangent line and the vertical axis 60 for each slanted plates 431. It can be observed that the included angles corresponding to the tangent lines are progressively increasing as the points move farther away from the center axis 60, angle_A<angle_B<angle_C, which means the curvature of the dish shaped light emergent plane 43 is progressively increasing toward the outer periphery.

The light distribution pattern of the above mentioned backlight module is similar to that shown in FIG. 6, that means the light coverage is enlarged, and the light received at the periphery is stronger than that near the center axis. This is made possible by the deflection of light from the center axis 60 to supplement light in the peripheral areas. As a result of that, the light homogeneity on the planar surface is significantly improved, and the image quality is also enhanced.

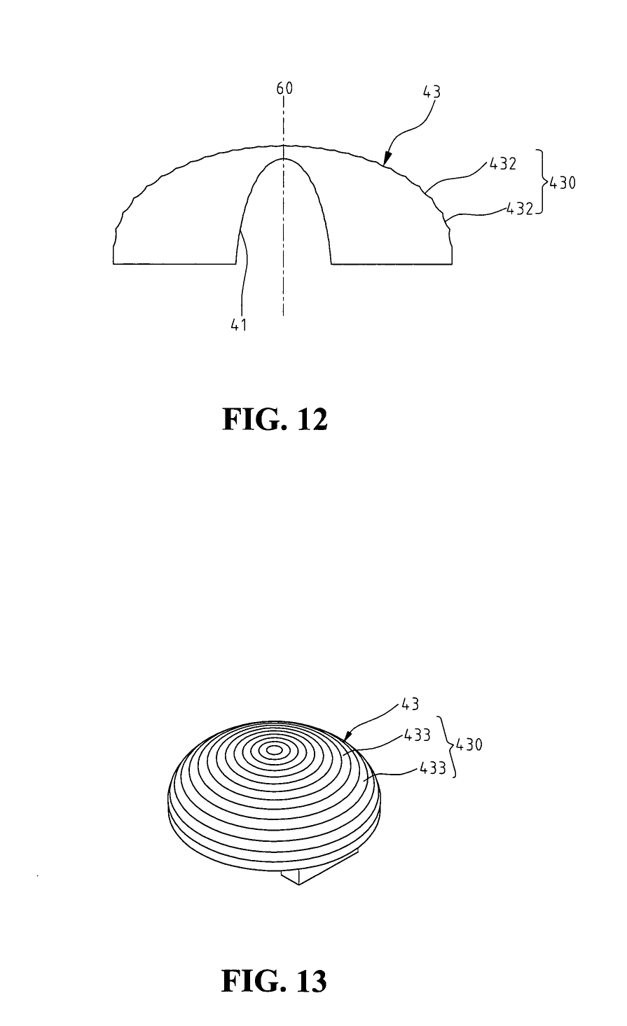

Referring to FIGS. 11, 12, still another backlight module construction is used in the third preferred embodiment of the invention, in which the light emergent plane 43 of the dome lens 40 is formed by multiple small hoop lenses 430 in concentric orientation, where each hoop lens 430 is a slanted plate 432 with negative curvature. The slanted plates 432 are joined in an expanding manner from the inner most ring near the center axis 60 to the outer periphery, so that an inward curving light emergent plane 43 is formed with negative curvature. The light emergent plane 43 is dished shape with undulating surface.

From the center axis of the dome shaped surface 40, tangent lines are drawn tangent parallel to the slanted surface of the hoop lenses 432, so included angles between the center axis 60 and the corresponding tangent lines are drawn as shown in FIG. 12. Because of the negative curvature of the hoop lenses 432, the light distribution through the hoop lens 432 tends to overlap each other. This light distribution pattern allows appropriate amount of light mixing, so that the light homogeneity of light and the image quality of the LCD monitor can be further improved.

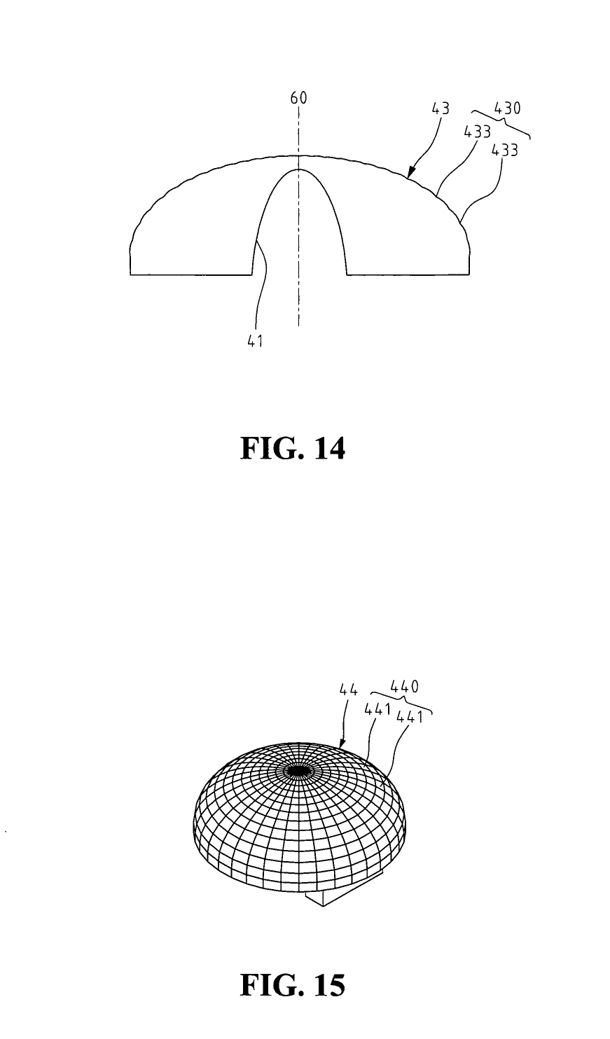

Referring to FIGS. 13, 14, still another backlight module construction is used in the fourth preferred embodiment of the invention, in which the light emergent plane 43 of the dome lens 40 is formed by multiple small hoop lenses 430 in concentric orientation. Each hoop lens 430 is slanted plate 433 with positive curvature that is outward curving. The hoop lenses 433 are joined in concentric formation expanding from the innermost ring near the center axis to the outer periphery to form the dished shape with undulating surface.

From the center axis of the dome shaped surface 40, tangent lines are drawn parallel to the slanted surface of the hoop lenses 433, so included angles between the center axis 60 and the corresponding tangent lines are measured as shown in FIG. 14. Because of the positive curvature characteristics of the hoop lenses 433, the light distribution through the hoop lens 433 tends to be more scattered. This light distribution pattern allows even wider light coverage, so that the light homogeneity in the distant area and the image quality can be further improved.

Referring to FIG. 15, still another backlight module construction is used in the fifth preferred embodiment of the invention, in which the light emergent plane 44 of the dome lens 40 is formed by multiple small diamond lenses 440. Since the size of each diamond lens 440 is smaller than the hoop lens 431, so a predetermined number of diamond shaped lenses 441 are used to replace the previous hoop lens 431. Diamond lenses 441 are joined in a grid formation to form a light emergent plane 44 with zero curvature. The pattern is radiating from the center axis 60 to the outer periphery to form the dished shape plane 44 with undulating surface. This design enables wide viewing angle from multiple bands among the vertical and horizontal axis.

Because of the flat surface of the diamond lenses 441, the light distribution through the diamond lenses 441 basically resemble that of the hoop lenses 431. This light pattern allows more refined light mixing to enhance the light homogeneity and the image quality.

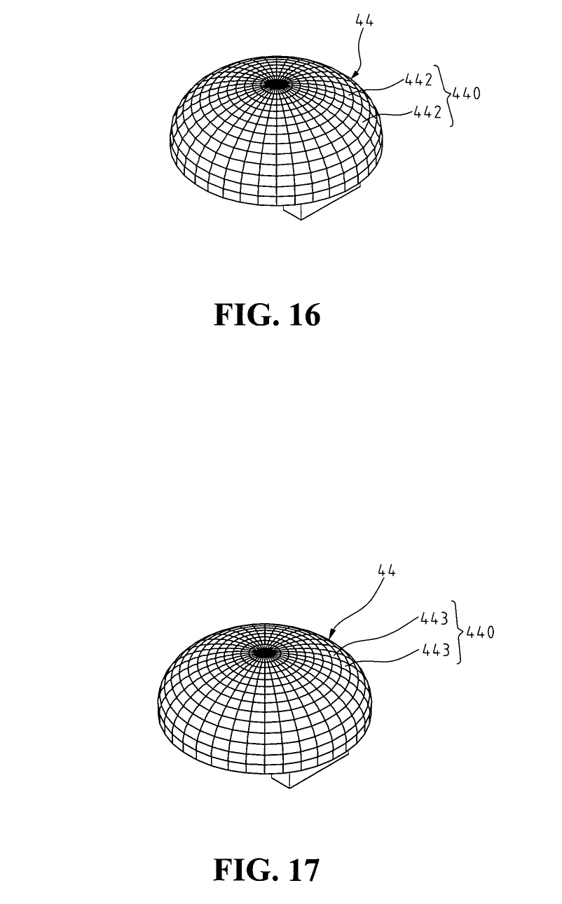

Referring to FIGS. 16, 17, still another backlight module construction is used in the sixth preferred embodiment of the invention, in which the light emergent plane 44 of the dome lens 40 is formed by multiple small diamond lenses 442, inward curving with negative curvature. The diamond lenses 442 are joined in a grid formation radiating from the center axis to the outer periphery to form the dished shape with undulating surface.

Because of the negative curvature on the surface of the diamond lenses 442, the light distribution through the diamond lenses 442 are more likely to overlap with each other than any one of those previously mentioned. This light pattern allows more refined light mixing to enhance the light homogeneity and the image quality.

Still yet another backlight module construction is used in the seventh preferred embodiment of the invention, in which the light emergent plane 44 of the dome lens 40 is formed by multiple small diamond lenses 443, outward curving with positive curvature. These diamond lenses 443 are joined in a grid formation, radiating from the center axis to the outer periphery to form the dished shape with undulating surface.

Because of the positive curvature on the surface of the diamond lenses 443, the light distribution through the diamond lens 443 will be more scattered than any one of those previously mentioned. This light distribution pattern allows light projection to more distant areas and even wider light coverage, so that the light homogeneity in the peripheral areas is further enhanced.

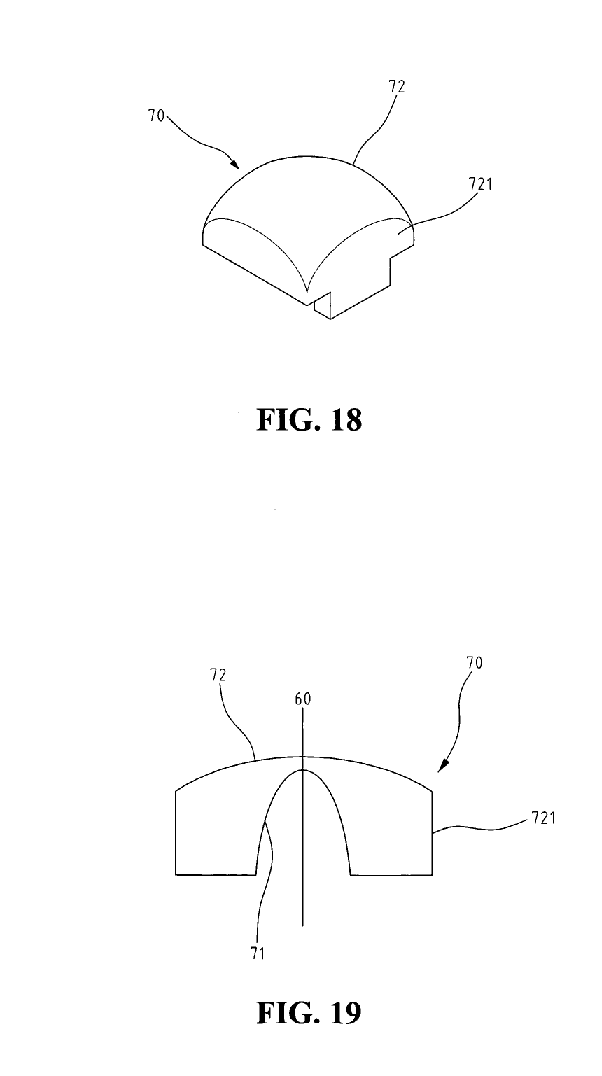

Referring to FIGS. 18, 19, still yet another backlight module construction is used in the eighth preferred embodiment of the invention, in which the lens has a dome-shaped cap and a rhombus-shaped bottom block with four vertical planes on the four sides. The lens 70 has a cone shaped light incident plane 71 near the center axis, a light emergent plane 72 with an outward curving section on top and four vertical planes on the four sides 721. The light incident plane 71 progressively decreases in curvature from the center axis to the outer edges, whereas the light emergent plane 72 progressively increases in curvature only half way through, and then drastically bends toward the four vertical sides.

The light emergent plane 72 of the dome lens 70 is formed by multiple small hoop lenses 440 in concentric orientation. These hoop lenses are joined in concentric formation expanding from the center axis to the outer periphery of the dome. Light beams incident from the LED light source will be deflected to the lateral sides with more illumination on the periphery.

The lens surface can be shaped with zero, negative, or positive curvature depending on the requirement specifications for the light distribution lens.

The lens surface can also be formed by smaller diamond shaped lenses as previously described, and the curvature of individual lens in the horizontal and vertical axis can be the same or different, depending on the requirement specifications for the light distribution lens.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A method of backlighting, comprising the steps of:
preparing a dome lens having a light incident plane and a light emergent plane;
preparing a LED light source; and
fitting the dome lens over the light source; wherein
when light beams incident from the light source pass through the dome lens, the light is first distributed by the outward curving light incident plane progressively decreasing in curvature toward the outer periphery, and then by the inward curving light emergent plane progressively increasing in curvature from the center axis toward the outer periphery.

2. The method of backlighting as claimed in claim 1, wherein the coupled dome lens and light source is attached onto a base block directly underneath the optical lens sheet, in such a way that the optical lens sheet closest to the light source has a vertical distance X therefrom, enabling the light beams to be projected onto the optical lens sheet covering a wide area with diameters ranging from 2X to 7X.

3. The method of backlighting as claimed in claim 2, wherein the light homogeneity is maintained over 75% within the circular peripheral areas with diameters ranging from 2X to 7X.

4. The method of backlighting as claimed in claim 1, wherein the LED light source is generated by a white light LED lamp.

5. The method of backlighting as claimed in claim 1, wherein the LED light source is formed by multiple SMD LEDs.

6. A backlight module, comprising:
a dome lens in the form of a hemispherical body, having an outward curving light incident plane around hollow cavity in the center, and an inward curving light emergent plane on top surface, wherein the light incident plane progressively decreases in curvature from the center axis to the outer periphery, and the light emergent plane progressively increases in curvature from the center axis to the outer periphery.

7. The backlight module as claimed in claim 6, wherein the light emergent plane of the dome lens is formed by multiple hoop lenses in concentric circles orientation, expanding outward from the center axis.

8. The backlight module as claimed in claim 7, wherein the light distribution hoop lenses are flat with zero curvature.

9. The backlight module as claimed in claim 7, wherein the light distribution hoop lenses are inward curving with negative curvature.

10. The backlight module as claimed in claim 7, wherein the light distribution hoop lenses are outward curving with positive curvature.

11. The backlight module as claimed in claim 6, wherein the light distribution lenses are formed by multiple smaller diamond lenses in a grid pattern radiating outward from the center axis.

12. The backlight module as claimed in claim 11, wherein the small diamond lenses are inward curved with zero curvature.

13. The backlight module as claimed in claim 11, wherein the small diamond lenses are outward curved with negative curvature.

14. The backlight module as claimed in claim 13, wherein the curvature of individual inward curving diamond lens among the horizontal and vertical axis is the same.

15. The backlight module as claimed in claim 13, wherein the curvature of individual diamond lens along the horizontal and vertical axis is different.

16. The backlight module as claimed in claim 11, wherein the small diamond lenses are outward curved with positive curvature.

17. The backlight module as claimed in claim 16, wherein the curvature of individual outward curved diamond lens among the horizontal and vertical axis is the same.

18. The backlight module as claimed in claim 16, wherein the curvature of individual outward curving diamond lens among the horizontal and vertical axis is different.

19. A backlight module, comprising:
a lens constructed with a dome-shaped cap and a rhombus shaped bottom block having four vertical planes on the four sides, where an outward curving light incident plane is formed around hollow cavity in the center, and an inward curving light emergent plane is disposed over the light incident plane, in such a way that the light incident plane progressively decreases in curvature from the center axis to the outer periphery, and the light emergent plane progressively increases in curvature from the center axis to the outer periphery.
